(19) United States
(12) Patent Application Publication
(10) Pub. No.: US 2007/0085772 A1
(43) Pub. Date: Apr. 19, 2007

(54) Plasma display apparatus and method of driving the same

(76) Inventors: Kirack PARK, Gyeongsangbuk-do (KR); Jongwoon Bae, Gumi-si (KR); Seonghwan Ryu, Gumi-si (KR); Yoonjoo Cho, Seoul (KR); Dooyong Wang, Yongin-si (KR)

Correspondence Address: FLESHNER & KIM, LLP, P.O. BOX 221200, CHANTILLY, VA, 20153, US

(21) Appl. No.: 11/549,221

(22) Filed: Oct. 13, 2006

(30) Foreign Application Priority Data
Oct. 13, 2005 (KR) 10-2005-0096761

(51) Int. Cl. G09G 3/28

(52) U.S. Cl. 345/67

(57) ABSTRACT

A plasma display apparatus and a method of driving the same are disclosed. In the plasma display apparatus, a scan driver supplies scan signals to a plurality of scan electrodes using a first scan type in a first subfield of a frame, and supplies the scan signals to the plurality of scan electrodes using a second scan type, which directs the scan driver to supply the scan signals in an order different from the first scan type, in a second subfield of the frame. Further, the scan driver consecutively supplies a first scan signal and a second scan signal to a first scan electrode and a second scan electrode of the plurality of scan electrodes. A supply end time point of the first scan signal is later than a supply start time point of the second scan signal.

This Nonprovisional application claims priority under 35 U.S.C. § 119(a) on Patent Application No. 10-2005-0096761 filed in Korea on Oct. 13, 2005 the entire contents of which are hereby incorporated by reference.

### BACKGROUND

1. Field

This document relates to a plasma display apparatus and a method of driving the same.

2. Description of the Related Art

A plasma display panel comprises a front panel, a rear panel and barrier ribs formed between the front panel and the rear panel. The barrier ribs forms unit discharge cell or discharge cells. Each of discharge cells is filled with an inert gas containing a main discharge gas such as neon (Ne), helium (He) and a mixture of Ne and He, and a small amount of xenon (Xe). When it is discharged by a high frequency voltage, the inert gas generates vacuum ultra-violet rays, which thereby cause a phosphor formed inside the discharge cell to emit light, thus displaying an image. Since the plasma display panel can be manufactured to be thin and light, it has attracted attention as a next generation display device.

A plurality of electrodes, for example, a scan electrode, a sustain electrode and a data electrode are formed in the plasma display panel. A driver supplies a predetermined driving voltage to the plurality of electrodes to generate a discharge such that an image is displayed. The driver for supplying the predetermined driving voltage to the plurality of electrodes of the plasma display panel is connected to the plurality of electrodes in the form of a driver integrated circuit (IC).

For example, a data driver IC is connected to the data electrode of the plasma display panel, and a scan driver IC is connected to the scan electrode of the plasma display panel.

When driving the plasma display panel, the displacement current flows in these driver ICs. A magnitude of the displacement current varies by various factors.

For example, a displacement current flowing in the data driver IC may increase or decrease depending on equivalence capacitance of the plasma display panel and the number of switching operations of the data driver IC.

In particular, when image data is a specific pattern where logical values 1 and 0 are repeatedly input, the displacement current flowing in the data driver IC excessively increases such that the data driver IC is electrically damaged.

### SUMMARY OF THE INVENTION

In one aspect, a plasma display apparatus comprises a plurality of scan electrodes, a plurality of data electrodes supplied with a data signal, a scan driver for supplying scan signals to the plurality of scan electrodes using a first scan type in a first subfield of a frame, and for supplying the scan signals to the plurality of scan electrodes using a second scan type, which directs the scan driver to supply the scan signals in an order different from the first scan type, in a second subfield of the frame, and a data driver for supplying data signals corresponding to the scan signals supplied in the first subfield and the second subfield to the plurality of data electrodes, wherein the scan driver consecutively supplies a first scan signal and a second scan signal to a first scan electrode and a second scan electrode of the plurality of scan electrodes, and a supply end time point of the first scan signal is later than a supply start time point of the second scan signal.

In another aspect, a method of driving a plasma display apparatus comprising a plurality of scan electrodes and a plurality of data electrodes, comprises supplying scan signals to the plurality of scan electrodes using a first scan type in a first subfield of a frame, supplying the scan signals to the plurality of scan electrodes using a second scan type, which is different from the first scan type in an order of supplying the scan signals, in a second subfield of the frame, and supplying data signals corresponding to the scan signals supplied in the first subfield and the second subfield to the plurality of data electrodes, wherein a first scan signal and a second scan signal are consecutively supplies to a first scan electrode and a second scan electrode of the plurality of scan electrodes, and a supply end time point of the first scan signal is later than a supply start time point of the second scan signal.

### BRIEF DESCRIPTION OF THE DRAWINGS

The accompany drawings, which are included to provide a further understanding of the invention and are incorporated on and constitute a part of this specification illustrate embodiments of the invention and together with the description serve to explain the principles of the invention.

FIG. 1 illustrates a plasma display apparatus according to an embodiment;

FIG. 2 illustrates a plasma display panel of the plasma display apparatus according to the embodiment;

FIG. 3 illustrates a method for achieving a gray level of an image in the plasma display apparatus according to the embodiment;

FIG. 4 illustrates a method for driving the plasma display apparatus according to the embodiment;

FIGS. 5a and 5b illustrate a magnitude of a displacement current depending on input image data;

FIG. 6 illustrates a plurality of scan types each having a different order of supplying scan signals to a plurality of scan electrodes;

FIG. 7 illustrates one example of a method for determining a scan type to be applied to each scan electrode block;

FIG. 8 illustrates another example of a method for determining a scan type relative to a threshold value of the number of switching operations of a data driver;

FIG. 9 illustrates an example of applying a plurality of scan types each having a different order of supplying scan signals to a plurality of scan electrode groups each comprising a plurality of scan electrodes;

FIG. 10 illustrates one example of a method for determining a scan type in consideration of a subfield;

FIG. 11 illustrates one example of a waveform of a driving signal of the plasma display apparatus according to the embodiment;

FIGS. 12a and 12b illustrate a supply start time point and a supply end time point of a scan signal for driving the plasma display apparatus according to the embodiment;

FIG. 13 illustrates the supplying of scan signals to three or more scan electrodes of the plasma display apparatus according to the embodiment in a consecutive order;

FIG. 14 illustrates an example of scan signals supplied by a scan driver of the plasma display apparatus according to the embodiment using a second scan type;

FIG. 15 illustrates another example of scan signals supplied by a scan driver of the plasma display apparatus according to the embodiment using a first scan type; and

FIG. 16 illustrates another example of scan signals supplied by a scan driver of the plasma display apparatus according to the embodiment using a second scan type.

### DETAILED DESCRIPTION OF PREFERRED EMBODIMENTS

Preferred embodiments of the present invention will be described in a more detailed manner with reference to the drawings.

A plasma display apparatus comprises a plurality of scan electrodes, a plurality of data electrodes supplied with a data signal, a scan driver for supplying scan signals to the plurality of scan electrodes using a first scan type in a first subfield of a frame, and for supplying the scan signals to the plurality of scan electrodes using a second scan type, which directs the scan driver to supply the scan signals in an order different from the first scan type, in a second subfield of the frame, and a data driver for supplying data signals corresponding to the scan signals supplied in the first subfield and the second subfield to the plurality of data electrodes, wherein the scan driver consecutively supplies a first scan signal and a second scan signal to a first scan electrode and a second scan electrode of the plurality of scan electrodes, and a supply end time point of the first scan signal is later than a supply start time point of the second scan signal.

The number of times of switching of the data driver with respect to the first scan type in the first subfield may be less than the number of times of switching of the data driver with respect to the second type in the first subfield.

The number of switching operations of the data driver may equal the number of changes in a voltage level of the data signal.

At least one of the first scan type and the second scan type may comprise a scan type for consecutively supplying the scan signals to the odd-numbered scan electrodes and then to the even-numbered scan electrodes, or for consecutively supplying the scan signals to the even-numbered scan electrodes and then to the odd-numbered scan electrodes.

The plurality of scan electrodes may comprise a first scan electrode, a second scan electrode, and a third scan electrode, adjacent to one another, to which the scan signals are supplied in a consecutive order, wherein a distance between the first scan electrode and the second scan electrode may be substantially equal to a distance between the second scan electrode and the third scan electrode.

The scan driver may supply the scan signals to the scan electrodes using one of the first scan type and the second scan type, in which the number of times of switching of the data driver is less than the other, in response to image data input for each subfield of the frame.

At least one of the first scan type and the second scan type may comprise a scan type for consecutively supplying the scan signals to the scan electrodes of one scan electrode group.

The scan driver may supply the scan signals to the plurality of scan electrodes using at least one of the first scan type and the second scan type, in which the number of switching operations of the data driver in response to input image data is equal to or less than a threshold value.

When the number of switching operations of the data driver with respect to the first scan type in response to input image data may be equal to or more than a threshold value, the scan driver supplies the scan signals to the scan electrodes using the second scan type.

The first scan type may comprise a scan type for consecutively supplying the scan signals to the plurality of scan electrodes. The scan driver may supply the scan signals to the scan electrodes using the first scan type when the number of switching operations of the data driver with respect to the first scan type in response to input image data is equal to or less than a threshold value, and the scan driver may supply the scan signals to the scan electrodes using the second scan type when the number of switching operations of the data driver with respect to the first scan type in response to input image data is equal to or more than the threshold value.

The supply start time point of the second scan signal may occur when a voltage of the second scan electrode is equal to or less than 90% of the highest voltage of the second scan signal.

The supply end time point of the first scan signal may occur when a voltage of the first scan electrode is equal to or more than 90% of the highest voltage of the first scan signal.

An interval of time between the supply end time point of the first scan signal and the supply start time point of the second scan signal may range from 10 ns to 500 ns.

An interval of time between the supply end time point of the first scan signal and the supply start time point of the second scan signal may range from 1/100 to ½ times the width of the first scan signal or the second scan signal.

A method of driving a plasma display apparatus comprising a plurality of scan electrodes and a plurality of data electrodes, comprises supplying scan signals to the plurality of scan electrodes using a first scan type in a first subfield of a frame, supplying the scan signals to the plurality of scan electrodes using a second scan type, which is different from the first scan type in an order of supplying the scan signals, in a second subfield of the frame, and supplying data signals corresponding to the scan signals supplied in the first subfield and the second subfield to the plurality of data electrodes, wherein a first scan signal and a second scan signal are consecutively supplies to a first scan electrode and a second scan electrode of the plurality of scan electrodes, and a supply end time point of the first scan signal is later than a supply start time point of the second scan signal.

The supply start time point of the second scan signal may occur when a voltage of the second scan electrode is equal to or less than 90% of the highest voltage of the second scan signal.

The supply end time point of the first scan signal may occur when a voltage of the first scan electrode is equal to or more than 90% of the highest voltage of the first scan signal.

An interval of time between the supply end time point of the first scan signal and the supply start time point of the second scan signal may range from 10 ns to 500 ns.

An interval of time between the supply end time point of the first scan signal and the supply start time point of the second scan signal may range from 1/100 to ½ times the width of the first scan signal or the second scan signal.

Hereinafter, exemplary embodiments of the present invention will be described in detail with reference to the attached drawings.

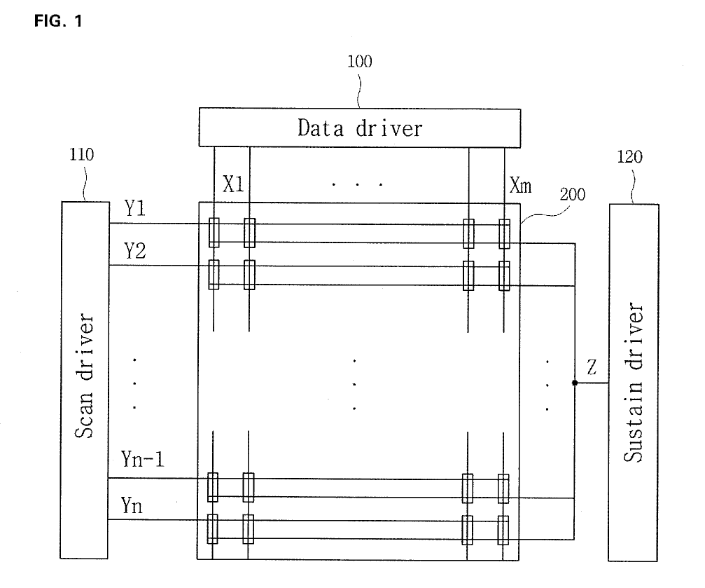

FIG. 1 illustrates a plasma display apparatus according to an embodiment. As illustrated in FIG. 1, the plasma display apparatus according to the embodiment comprises a plasma display panel 200, a data driver 100, a scan driver 110, and a sustain driver 120.

Although FIG. 1 illustrates the data driver 100, the scan driver 110 and the sustain driver 120 as being formed in different board shapes, respectively, at least two of the data driver 100, the scan driver 110, and the sustain driver 120 may be integrated in one board.

The plasma display panel 200 comprises a front panel (not illustrated) and a rear panel (not illustrated) which are coalesced with each other at a given distance. Further, the plasma display panel 200 comprises a plurality of electrodes, for example, scan electrodes Y1 to Yn, sustain electrodes Z formed in parallel to the scan electrodes Y1 to Yn, and data electrodes X1 to Xm formed to intersect the scan electrodes Y1 to Yn and the sustain electrodes Z.

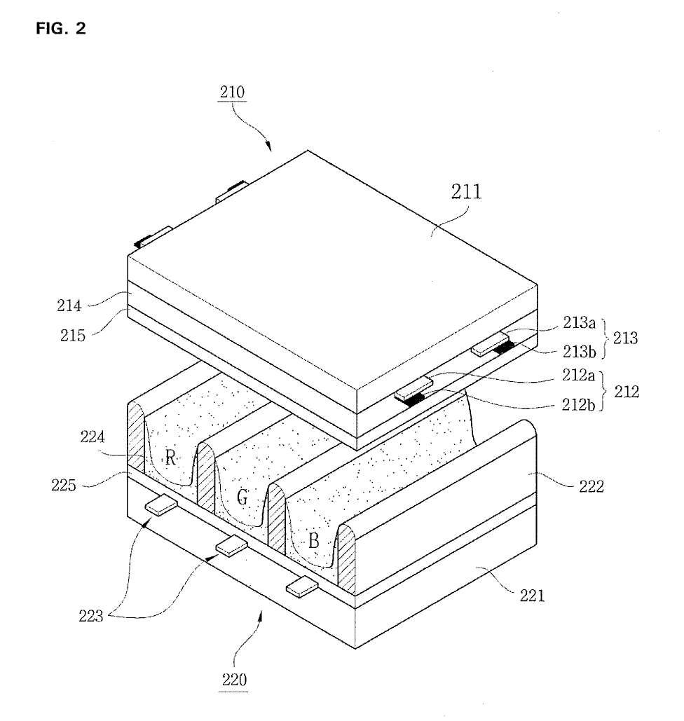

The following is a detailed description of the plasma display panel 200, with reference to FIG. 2.

FIG. 2 illustrates a plasma display panel of the plasma display apparatus according to the embodiment.

As illustrated in FIG. 2, the plasma display panel comprises a front panel 210 and a rear panel 220 which are coupled in parallel to oppose to each other at a given distance therebetween. The front panel 210 comprises a front substrate 211 which is a display surface. The rear panel 220 comprises a rear substrate 221 constituting a rear surface. A plurality of scan electrodes 212 and a plurality of sustain electrodes 213 are formed in pairs on the front substrate 211, on which an image is displayed, to form a plurality of maintenance electrode pairs. A plurality of data electrodes 223 are arranged on the rear substrate 221 to intersect with the plurality of maintenance electrode pairs.

The scan electrode 212 and the sustain electrode 213 each comprise transparent electrodes 212a and 213a made of transparent indium-tin-oxide (ITO) material and bus electrodes 212b and 213b made of a metal material. The scan electrode 212 and the sustain electrode 213 generate a mutual discharge therebetween in one discharge cell and maintain light emissions of discharge cells. The scan electrode 212 and the sustain electrode 213 each may comprise the transparent electrodes 212a and 213a. Further, the scan electrode 212 and the sustain electrode 213 each may comprise the bus electrodes 212b and 213b. The scan electrode 212 and the sustain electrode 213 are covered with one or more upper dielectric layers 214 to limit a discharge current and to provide insulation between the maintenance electrode pairs. A protective layer 215 with a deposit of MgO is formed on an upper surface of the upper dielectric layer 214 to facilitate discharge conditions.

A plurality of stripe-type (or well-type) barrier ribs 222 are formed in parallel on the rear substrate 221 of the rear panel 220 to form a plurality of discharge spaces (i.e., a plurality of discharge cells). The plurality of data electrodes 223 for performing an address discharge to generate vacuum ultraviolet rays are arranged in parallel to the barrier ribs 222. An upper surface of the rear substrate 221 is coated with Red (R), green (G) and blue (B) phosphors 224 for emitting visible light for an image display when an address discharge is performed. A lower dielectric layer 225 is formed between the data electrodes 223 and the phosphors 224 to protect the data electrodes 223.

The front panel 210 and the rear panel 220 are coalesced by a sealing process such that the plasma display panel is formed. A driving circuit substrate (not illustrated), on which drivers for supplying driving voltages to the scan electrode 212, the sustain electrode 213 and the data electrode 223 are formed, are disposed on a rear surface of the plasma display panel.

Referring again to FIG. 1, the scan driver 110 may supply a rising signal and a falling signal to the scan electrodes Y1 to Yn during a reset period. The scan driver 110 may supply a sustain signal to the scan electrodes Y1 to Yn during a sustain period. The scan driver 110 may supply scan signals to the scan electrodes Y1 to Yn during an address period using at least one scan type of a plurality of scan types which are different from one another in the order of supplying the scan signals to the plurality of scan electrodes. More specifically, the scan driver 110 supplies the scan signals to the scan electrodes Y1 to Yn using a first scan type in a first subfield of a frame, and supplies the scan signals to the scan electrodes Y1 to Yn using a second scan type, in which is different from the first scan type in the order of supplying the scan signals to the plurality of scan electrodes, in a second subfield of the frame. In particular, the scan driver 110 consecutively supplies a first scan signal and a second scan signal to a first scan electrode and a second scan electrode of the plurality of scan electrodes. A supply end time point of the first scan signal is later than a supply start time point of the second scan signal.

The sustain driver 120 supplies a sustain signal to the sustain electrodes Z during the sustain period. The sustain driver 120 and the scan driver 110 alternately operate. Further, the sustain driver 120 supplies a bias signal of a positive polarity to the sustain electrodes Z during the address period.

The data driver 100, under the control of a timing controller (not illustrated), supplies a data signal to the data electrodes X1 to Xm. The data signal supplied to the data driver 100 corresponds to the scan signal supplied by the scan driver 110.

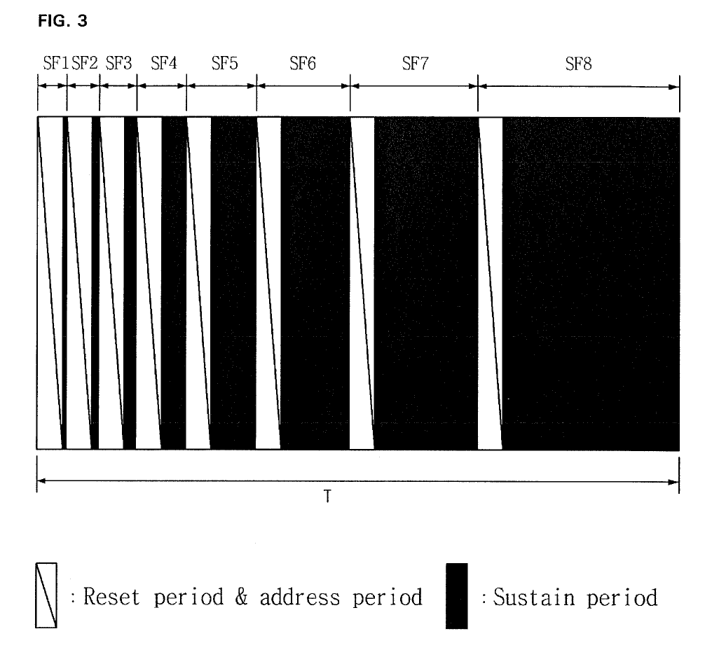

The plasma display apparatus comprising the above-described plasma display panel achieves a gray level of each of various images in a frame divided into a plurality of subfields. The following is a detailed description of a method for achieving a gray level of an image in the plasma display apparatus according to the embodiment, with reference to FIG. 3.

FIG. 3 illustrates a method for achieving a gray level of an image in the plasma display apparatus according to the embodiment. As illustrated in FIG. 3, a frame in the plasma display apparatus is divided into several subfields having a different number of emission times. Each of the subfields is subdivided into a reset period for initializing all the cells, an address period for selecting cells to be discharged, and a sustain period for representing gray level in accordance with the number of discharges.

For example, if an image with 256-level gray level is to be displayed, a frame period is divided into eight subfields SF1 to SF8. Each of the eight subfields SF1 to SF8 is subdivided into a reset period, an address period and a sustain period.

The sustain period determines gray level weight in each of the subfields. For example, gray level weight of a first subfield is set to 2⁰, and gray level weight of a second subfield is set to 2¹. In other words, the sustain period increases in a ratio of 2ⁿ (where, n=0, 1, 2, 3, 4, 5, 6, 7) in each of the subfields. Since the sustain period varies from one subfield to the next subfield, a specific gray level is achieved by controlling the sustain period which are to be used for discharging each of the selected cells, i.e., the number of sustain discharges that are realized in each of the discharge cells.

The plasma display apparatus of the present invention uses a plurality of frames so as to display an image during 1 second. For example, 60 frames are used to display an image during 1 second. In such a case, the length of a frame is equal to 1/60 sec (i.e., 16.67 ms).

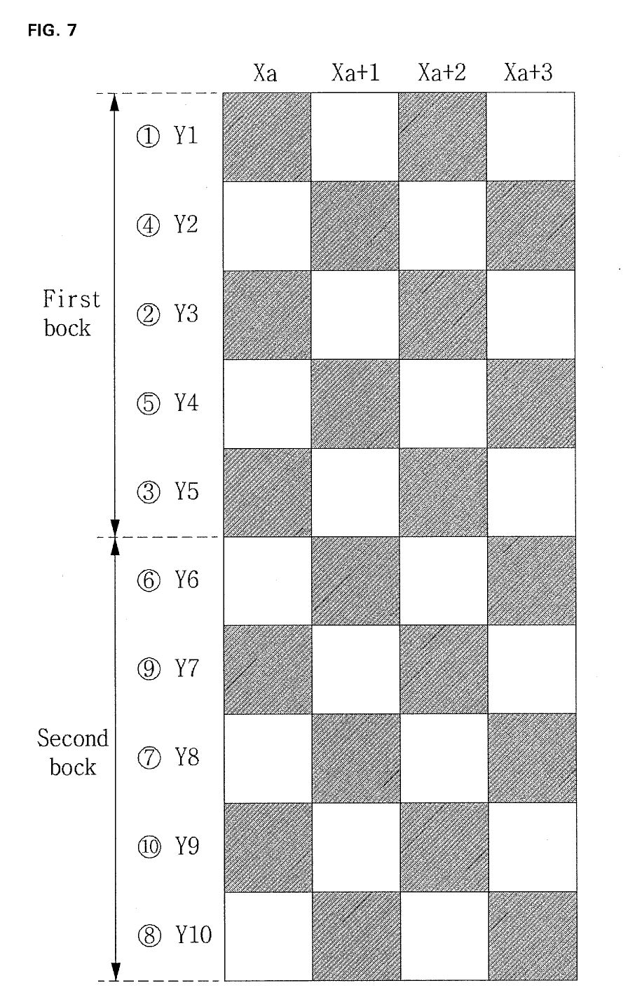

The explanation was given of an example of one frame comprising 8 subfields in FIG. 7. However, the number of subfields included in one frame may be variously changed. For example, one frame may comprise 12 subfields SF1 to SF12. Further, one frame may comprise 10 subfields SF1 to SF10.

Moreover, the subfields of one frame are arranged in increasing order of gray level weight in FIG. 7. However, the subfields may be arranged in decreasing order of gray level weight. Further, the subfields may be arranged irrespective of gray level weight.

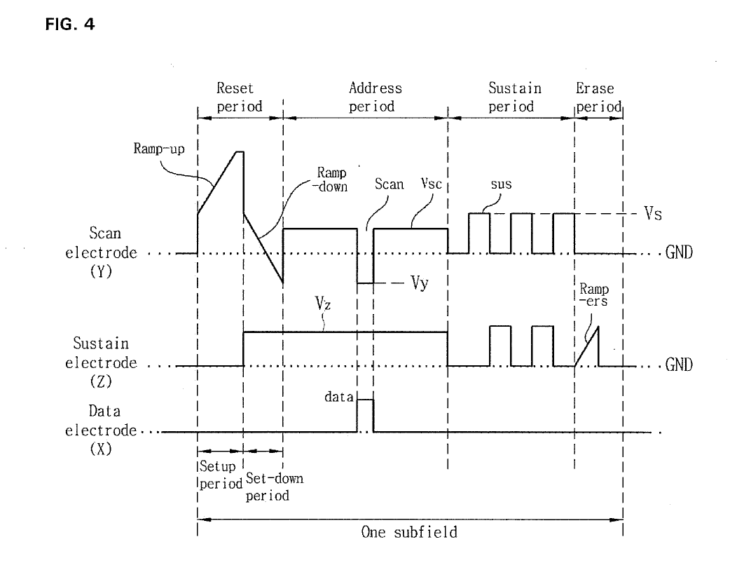

FIG. 4 illustrates a method for driving the plasma display apparatus according to the embodiment.

Each subfield is divided into a reset period for initializing all cells, an address period for selecting cells to be discharged, and a sustain period for discharge maintenance of the selected cells.

The reset period is further divided into a setup period and a set-down period. During the setup period, a set-up signal (Ramp-up) with a high voltage is simultaneously supplied to all scan electrodes Y, thereby generating a weak dark discharge within the discharge cells of the whole screen. This results in wall charges being accumulated within the cells.

During the set-down period, a set-down signal (Ramp-down) is simultaneously supplied to the scan electrodes Y, thereby generating a weak erase discharge within the cells. Furthermore, the remaining wall charges are uniform inside the cells to the extent that the address discharge can be stably performed. The set-down signal (Ramp-down) may have a scan voltage (−Vy).

During the address period, a scan pulse (Scan) with the scan voltage (−Vy) is sequentially applied to the scan electrodes Y and, at the same time, a data signal (data) is selectively applied to the data electrodes X. As the voltage difference between the scan signal (Scan) and the data signal (data) is added to the wall voltage generated during the reset period, the address discharge occurs within the discharge cells to which the data pulse (data) is applied. Wall charges are formed inside the cells selected by performing the address discharge.

A positive voltage Vz is supplied to the sustain electrode Z during the set-down period and the address period so that an erroneous discharge does not occur between the sustain electrode Z and the scan electrode.

During the sustain period, a sustain signal (sus) is alternately supplied to the scan electrode Y and the sustain electrode Z such that a sustain discharge occurs.

In the driving of the plasma display apparatus according to the embodiment, an order of supplying the scan signals during the address period changes so as to reduce a magnitude of a displacement current.

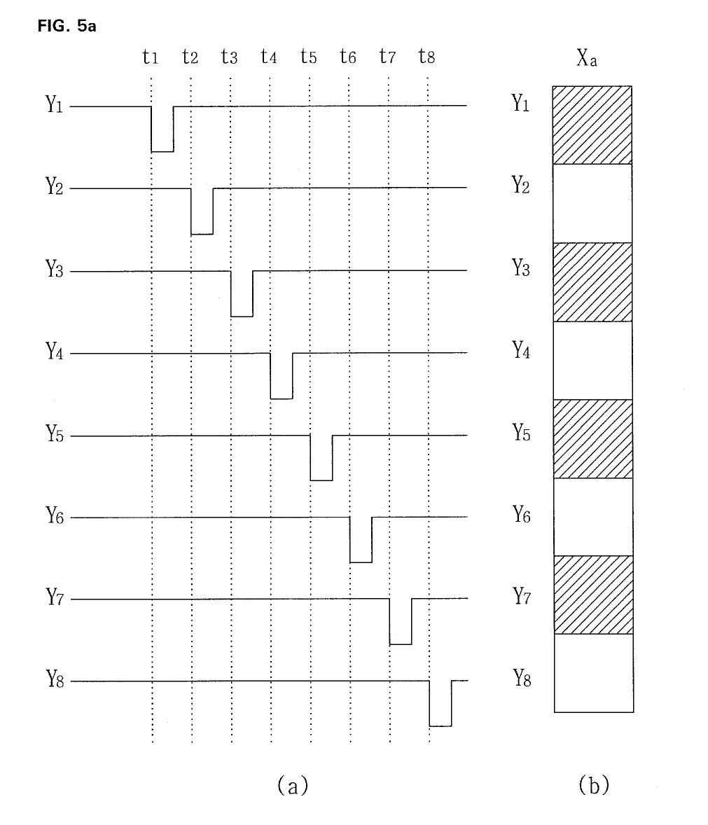

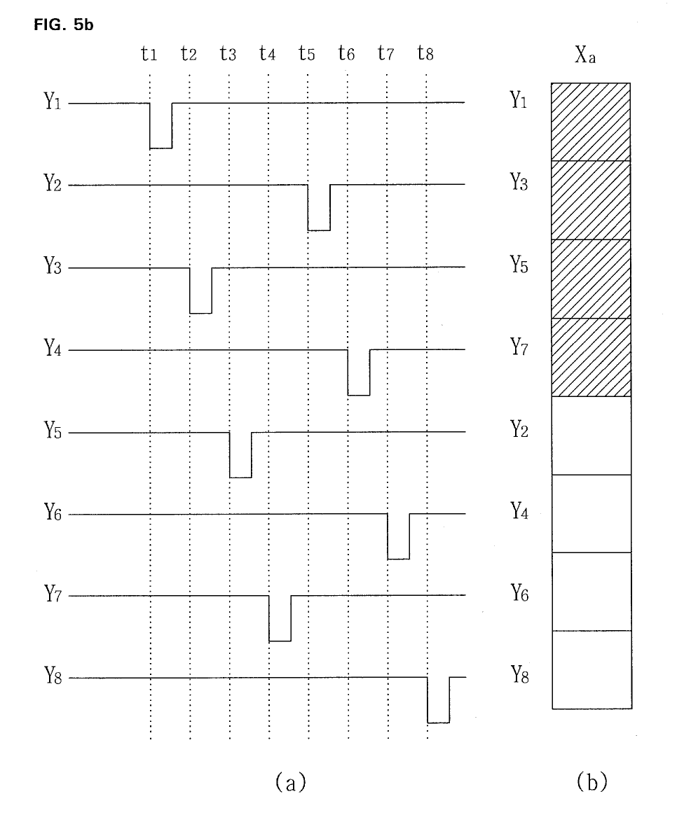

FIGS. 5a and 5b illustrate a magnitude of a displacement current depending on input image data.

Referring to FIG. 5a, (a) illustrates a method for consecutively supplying the scan signals to the first scan electrode Y1 to the eighth scan electrode Y8. In this case, as illustrated in (b) of FIG. 5a, data with a repeating pattern of high and low voltage levels may be supplied. For example, a data signal with a high voltage level is supplied to a discharge cell located at an intersection of an Xa data electrode and the second scan electrode Y2, a discharge cell located at an intersection of the Xa data electrode and the fourth scan electrode Y4, a discharge cell located at an intersection of the Xa data electrode and the sixth scan electrode Y6, and a discharge cell located at an intersection of the Xa data electrode and the eighth scan electrode Y8. Further, a data signal with a low voltage level is supplied to discharge cells located at intersections of the Xa data electrode and the remaining first, third, fifth and seventh scan electrodes Y1, Y3, Y5 and Y7.

In this case, the data driver consecutively performs on/off switching operations in order to supply the data signals with the repeating pattern of the high and low voltage levels. Accordingly, the number of switching operations of the data driver increases, thereby increasing the generation of a displacement current. Due to this, the possibility of an electrical damage to the data driver increases. The number of switching operations of the data driver may be equal to the number of changes in a voltage level of a data signal.

Next, referring to FIG. 5b, as compared to the case of FIG. 5a, there is a case where the scan signals are supplied to the first scan electrode Y1 to the eighth scan electrode Y8 using the scanning order different from the scanning order illustrated in FIG. 5a, and the data signal with the same pattern is supplied. For example, it is assumed that the scan signals are supplied to the first, third, fifth, seventh, second, fourth, sixth and eighth scan electrodes Y1, Y3, Y5, Y7, Y2, Y4, Y6, Y8 in the order named. That is, as compared to FIG. 5a, the pattern of data is the same, and the scanning order, i.e., the supply order of scan signals is different.

In this case, the data driver supplies a data signal with a high voltage level during the supplying of the scan signals to the first, third, fifth and seventh scan electrodes Y1, Y3, Y5 and Y7. The data driver supplies a data signal with a low voltage level during the supplying of the scan signals to the second, fourth, sixth and eighth electrodes Y2, Y4, Y6 and Y8.

In other words, when the scan signals are supplied to the first, second, third, fourth, fifth, sixth, seventh and eighth scan electrodes Y1, Y2, Y3, Y4, Y5, Y6, Y7, Y8 in the order named as illustrated in FIG. 5a, the data driver performs a total of seven times of switching operations. On the other hand, when the scan signals are supplied to the first, third, fifth, seventh, second, fourth, sixth, and eighth scan electrodes Y1, Y3, Y5, Y7, Y2, Y4, Y6, Y8 in the order named as illustrated in FIG. 5b, the data driver performs only a total of one time of switching operation. Accordingly, a magnitude of the displacement current generated in the data driver in FIG. 5b is reduced, thereby preventing the electrical damage to the data driver.

Although a scan type has been so far applied in consideration of only the number of changes in a voltage level of a data signal supplied to one data electrode, it is possible to apply a scan type in consideration of the difference in voltage levels of data signals supplied to two or more adjacent data electrodes.

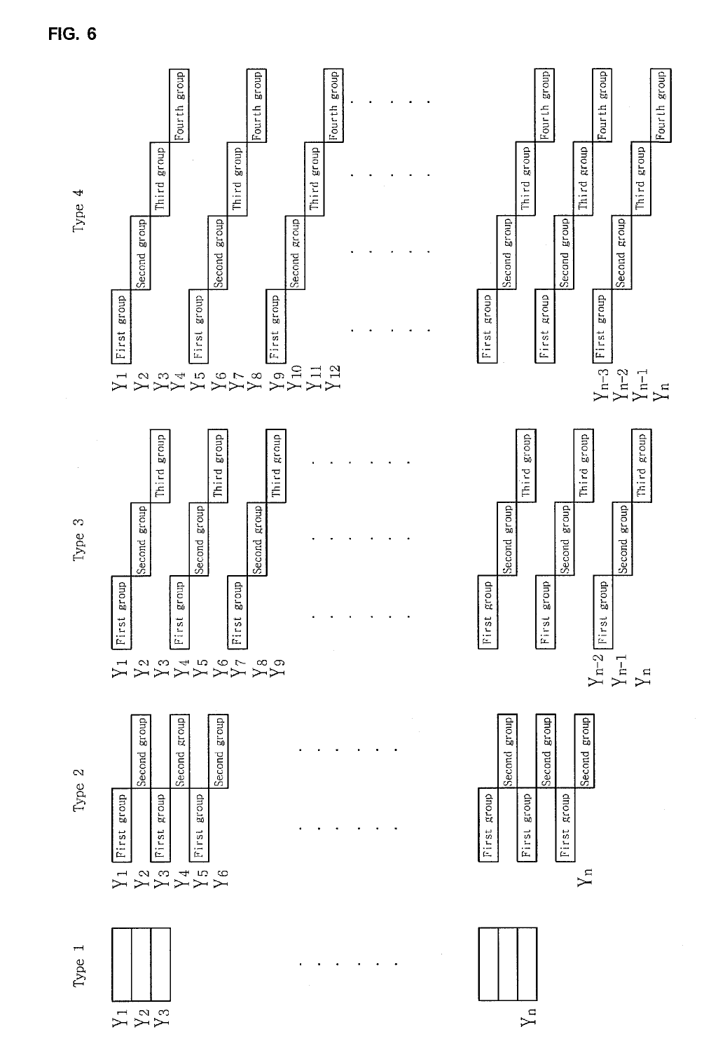

FIG. 6 illustrates a plurality of scan types each having a different order of supplying scan signals to a plurality of scan electrodes.

During the address, scan signals may be supplied to the plurality of scan electrodes using a plurality of scan types which are different from one another in the order of supplying the scan signals to the plurality of scan electrodes.

For example, scanning may be performed, i.e., scan signals may be supplied to the scan electrodes, using at least one scan type among a total of four scan types, e.g., a first scan type (Type1), a second scan type (Type2), a third scan type (Type3), and a fourth scan type (Type4).

The first scan type (Type1) is a scan type for supplying scan signals in the order of arrangement of the scan electrodes like the first, second, third, . . . scan electrodes Y1, Y2, Y3, . . .

The second scan type (Type2) is a scan type for consecutively supplying scan signals to odd-numbered scan electrodes and for consecutively supplying scan signals to even-numbered scan electrodes. For example, the second scan type (Type2) is a scan type for supplying scan signals in the order of the first, third, fifth, . . . , (n−1)-th scan electrodes Y1, Y3, Y5, . . . , (Yn−1), and for supplying scan signals in the order of the second, fourth, sixth, . . . , n-th scan electrodes Y2, Y4, Y6, . . . Yn. The first, third, fifth, . . . , (n−1)-th scan electrodes Y1, Y3, Y5, . . . (Yn−1) are grouped into the scan electrodes of a first group, and the second, fourth, sixth, . . . , n-th scan electrodes Y2, Y4, Y6, . . . Yn are grouped into the scan electrodes of a second group.

The third scan type (Type3) is a scan type for consecutively supplying scan signals to triple-numbered scan electrodes, i.e., for consecutively supplying scan signals to 3a-th scan electrodes, or for consecutively supplying scan signals to (3a+1)-th scan electrodes, or for consecutively supplying scan signals to (3a+2)-th scan electrodes, wherein a is an integer greater than 0. For example, the third scan type (Type3) is a scan type for supplying scan signals in the order of the first, fourth, seventh, . . . , (n−2)-th scan electrodes Y1, Y4, Y7, . . . , (Yn−2), for supplying scan signals in the order of the second, fifth, eighth, . . . , (n−1)-th scan electrodes Y2, Y5, Y8, . . . (Yn−1), and for supplying scan signals in the order of the third, sixth, ninth, . . . , n-th scan electrodes Y3, Y6, Y9, . . . , Yn. The first, fourth, seventh, . . . , (n−2)-th scan electrodes Y1, Y4, Y7, . . . (Yn−2) are grouped into the scan electrodes of a first group, the second, fifth, eighth, . . . (n−1)-th scan electrodes Y2, Y5, Y8, . . . , (Yn−1) are grouped into the scan electrodes of a second group, and the third, sixth, ninth, . . . , n-th scan electrodes Y3, Y6, Y9, . . . , Yn are grouped into the scan electrodes of a third group.

The fourth scan type (Type4) is a scan type for consecutively supplying scan signals to quadruple-numbered scan electrodes, i.e., for consecutively supplying scan signals to 4b-th scan electrodes, or for consecutively supplying scan signals to (4b+1)-th scan electrodes, or for consecutively supplying scan signals to (4b+2)-th scan electrodes, or consecutively supplies scan signals to (4b+3)-th scan electrodes, wherein b is an integer greater than 0. For example, the fourth scan type (Type4) is a scan type for supplying scan signals in the order of the first, fifth, ninth, . . . , (n−3)-th scan electrodes Y1, Y5, Y9, . . . , (Yn−3), for supplying scan signals in the order of the second, sixth, tenth, . . . , (n−2)-th scan electrodes Y2, Y6, Y10, . . . , (Yn−2), for supplying scan signals in the order of the third, seventh, eleventh, . . . , (n−1)-th scan electrodes Y3, Y7, Y11, . . . , Yn−1, and for supplying scan signals in the order of the fourth, eighth, twelfth, . . . , n-th scan electrodes Y4, Y8, Y12, . . . , Yn. The first, fifth, ninth, . . . , (n−3)-th scan electrodes Y1, Y5, Y9, . . . (Yn−3) are grouped into the scan electrodes of a first group, the second, sixth, tenth, . . . , (n−2)-th scan electrodes Y2, Y6, Y10, . . . , (Yn−2) are grouped into the scan electrodes of a second group, the third, seventh, eleventh, . . . , (n−1)-th scan electrodes Y3, Y7, Y11, . . . , Yn−1 are grouped into the scan electrodes of a third group, and the fourth, eighth, twelfth, . . . , n-th scan electrodes Y4, Y8, Y12, . . . , Yn are grouped into the scan electrodes of a fourth group.

For example, when the number of switching operations of the data driver with respect to the first scan type in the first subfield is less than the number of switching operations of the data driver with respect to the second scan type in the first subfield, the scan signals are supplied to the plurality of scan electrodes using the first scan type (Type1) in the first subfield.

On the contrary, when the number of switching operations of the data driver with respect to the second scan type in the second subfield is less than the number of switching operations of the data driver with respect to the first scan type in the second subfield, the scan signals are supplied to the plurality of scan electrodes using the second scan type (Type2) in the second subfield.

As above, different scan types may be supplied in different subfields.

As explained above, a distance between the scan electrodes belonging to one group to which scan signals are consecutively supplied may be kept substantially equal. For example, in the third scan type (Type3), among the first, fourth, and seventh scan electrodes Y1, Y4, and Y7 supplied with scan signals in the consecutive order, a distance between the first scan electrode Y1 and the fourth scan electrode Y4 is substantially equal to a distance between the fourth scan electrode Y4 and the seventh scan electrode Y7.

On the contrary, a distance between the scan electrodes belonging to one group to which scan signals are consecutively supplied may be set different from each other. For example, scan signals are consecutively supplied to the first scan electrode Y1, the second scan electrode Y2, and the seventh scan electrode Y7. A distance between the first scan electrode Y1 and the second scan electrode Y2 is different from a distance between the second scan electrode Y2 and the seventh scan electrode Y7.

Although FIG. 6 has illustrated and described a total of four scan types and the method for selecting at least one of the four scan types and supplying scan signals to scan electrodes Y in the order corresponding to the selected scan type, it is possible to provide various numbers of scan types such as two scan types, three scan types, and five scan types, and use the method for selecting at least one of these scan types and supplying scan signals to the scan electrodes Y in an order corresponding to the selected scan type.

As above, when the scan signals are supplied to the scan electrodes using the plurality of scan types, the scan signals are supplied to the scan electrodes using one scan type, in which the number of switching operations of the data driver in response to input image data is the smallest.

Alternatively, scan signals can be supplied to scan electrodes using at least one of the plurality of scan types in which the number of switching operations of the data driver in response to input image data is equal to or less than a threshold value. Here, the magnitude of the threshold value can be determined within a range of sufficiently protecting the data driver from an electrical damage.

FIG. 7 illustrates one example of a method for determining a scan type to be applied to each scan electrode block.

Referring to FIG. 7, in a first block comprising the first scan electrode Y1 to the fifth scan electrode Y5, scan signals are consecutively supplied in the order of the first, third, fifth, second, and fourth scan electrodes Y1, Y3, Y5, Y2, and Y4 as shown in the second scan type (Type2) of FIG. 6. Further, in a second block comprising the sixth scan electrode Y6 to the tenth scan electrode Y10, scan signals are consecutively supplied in the order of the sixth, eighth, tenth, seventh, and ninth scan electrodes Y6, Y8, Y1O, Y7, and Y9 as shown in the second scan type (Type2) of FIG. 6. Likewise, scan types may be set, respectively, for each block comprising one or more scan electrodes.

Although the number of scan electrodes belonging to each block has been set to be equal in the above, it is possible to set the number of scan electrodes belonging to at least one block different from the number of scan electrodes belonging to other blocks. For example, the first block may comprise 10 scan electrodes, while the second block may comprise 100 scan electrodes.

Further, although the above description has been made with respect to a case where the scan type supplied to each block is the same, the scan type supplied to at least one block may be different from the scan type supplied to other blocks. For example, the third scan type (Type3) of FIG. 6 may be applied to the first block, and the fourth scan type (Type4) of FIG. 6 may be applied to the second block.

Moreover, when different scan types are applied to each block, the scan signals are supplied to the scan electrodes using one scan type, in which the number of switching operations of the data driver in response to input image data for each block is the smallest.

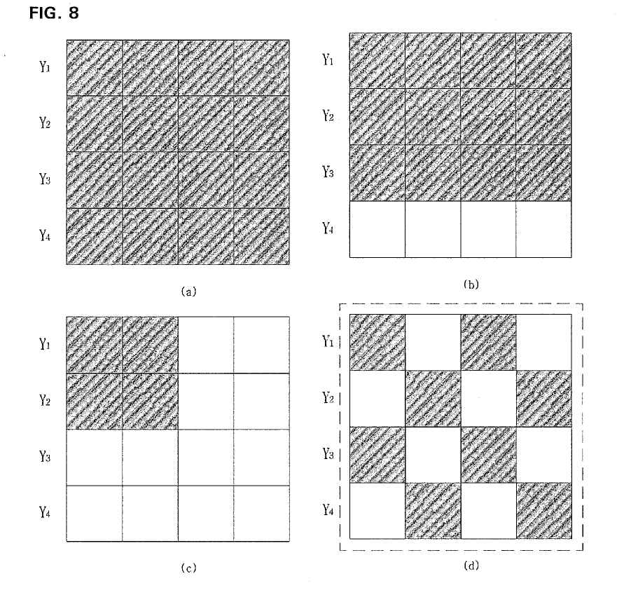

FIG. 8 illustrates another example of a method for determining a scan type relative to a threshold value of the number of switching operations of a data driver.

Referring to FIG. 8, when the number of switching operations of the data driver in response to input image data is equal to or more than a threshold voltage, the scan type may be changed.

For example, (a) illustrates a case where a data signal having a high voltage level is supplied to the discharge cells arranged on all the scan electrodes Y1 to Y4. (b) illustrates a case where a data signal having a high voltage level is supplied to the discharge cells arranged on the first, second, and third scan electrodes Y1, Y2, and Y3, and a data signal having a low voltage level is supplied to the discharge cell arranged on the fourth scan electrode Y4. (c) illustrates a case where a data signal having a high voltage level is supplied to the discharge cells arranged on the first and second scan electrodes Y1 and Y2, and a data signal having a low voltage level is supplied to the discharge cells arranged on the third and fourth scan electrodes Y3 and Y4. (d) illustrates a case where a data signal having a high voltage level is supplied to every other discharge cell.

In the case of (a), the total number of switching operations of the data driver is 0 because there occurs no change in a voltage level of a data signal. In the case of (b), the total number of switching operations of the data driver is equal to 4 because the voltage level of the data signal is changed a total of four times. In the case of (c), the total number of switching operations of the data driver is 2. In the case of (d), the total number of switching operations of the data driver is 12. Assuming that a total of 10 times of switching operations is a threshold value, only the image data of the last (d) pattern among image data of the (a), (b), (c), and (d) patterns may cause the number of switching operations to be greater than the threshold value.

As above, when the number of switching operations is equal to or more than the threshold value, this indicates that an electrical damage may be exerted on the data driver. Therefore, in case of image data of the (a), (b), and (c) patterns, the scan signals are supplied in the order of the first, second, third, and fourth scan electrodes Y1, Y2, Y3, and Y4. In case of image data of the (d) pattern, as shown in the second scan type (Type2) of FIG. 6, scan signals are supplied in the order of the first, third, second, and fourth scan electrodes Y1, Y3, Y2, and Y4. In this way, it is possible to change the scan type only in the case of image data of a specific pattern.

As above, when the number of switching operations of the data driver in response to input image data with respect to the first scan type (Type1) for sequentially supplying scan signals to the plurality of scan electrodes is equal to or less than the threshold value, the scan signals are supplied to the scan electrodes using the first scan type (Type1). On the other hand, when the number of switching operations of the data driver in response to input image data with respect to the first scan type (Type1) is greater than the threshold value, scan signals are supplied to the scan electrodes using the second scan type (Type2) which is different from the first scan type (Type1).

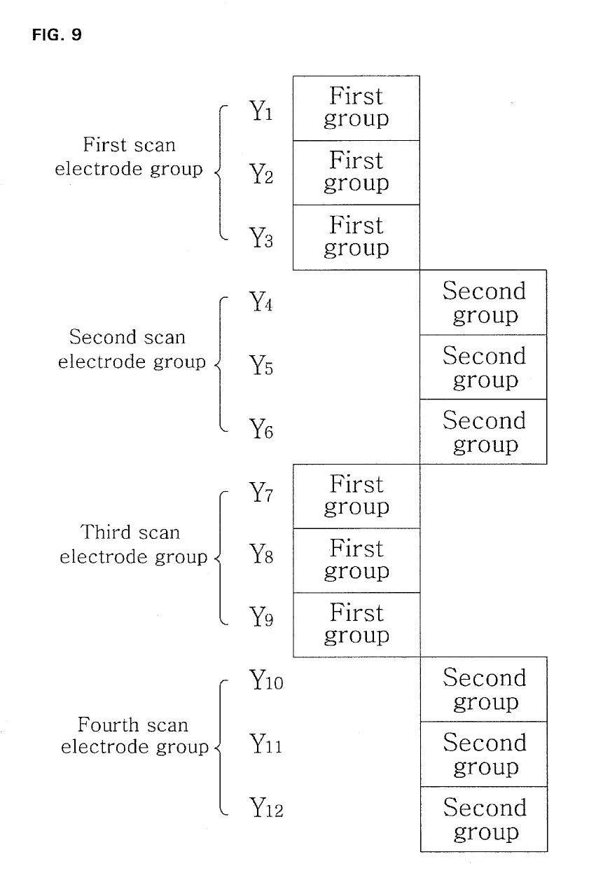

FIG. 9 illustrates an example of applying a plurality of scan types each having a different order of supplying scan signals to a plurality of scan electrode groups each comprising a plurality of scan electrodes.

Referring to FIG. 9, although the above description has been made with respect to a case where scan signals are supplied to the scan electrodes Y using a scan type having a scan order corresponding to each scan electrode Y, it is possible to divide the plurality of scan electrodes into a plurality of scan electrode groups and to supply scan signals to the plurality of scan electrode groups.

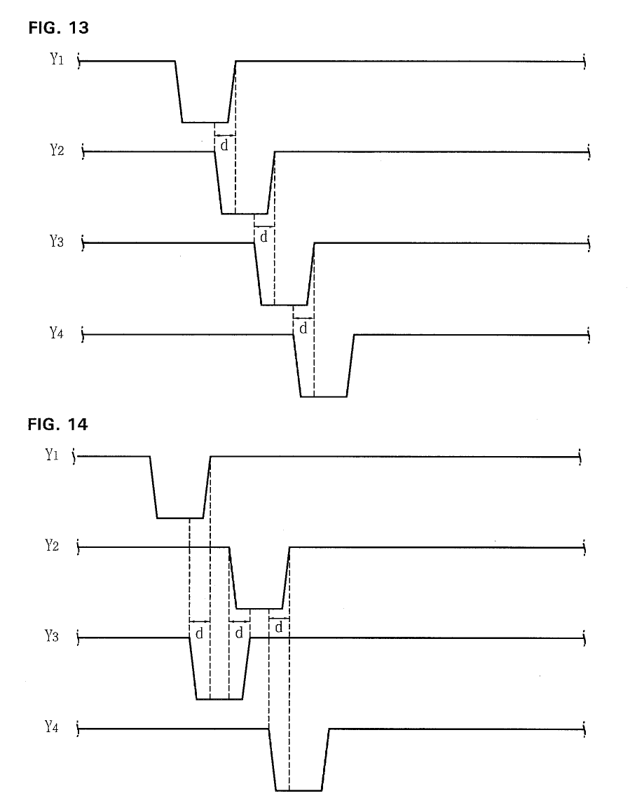

For example, the first, second, and third scan electrodes Y1, Y2, and Y3 are set to the first scan electrode group, the fourth, fifth, and sixth scan electrodes Y4, Y5, and Y6 are set to the second scan electrode group, the seventh, eighth, and ninth scan electrodes Y7, Y8, and Y9 are set to the third scan electrode group, and the tenth, eleventh, and twelfth scan electrodes Y1O, Y11, and Y12 are set to the fourth scan electrode group. Although in FIG. 13, each scan electrode group is set to comprise three scan electrodes, it is possible to variously change the number of scan electrodes to 2, 4, 5, etc.

Also, it is possible to set at least one of the plurality of scan electrode groups so as to comprise a different number of scan electrodes Y from the other scan electrode groups.

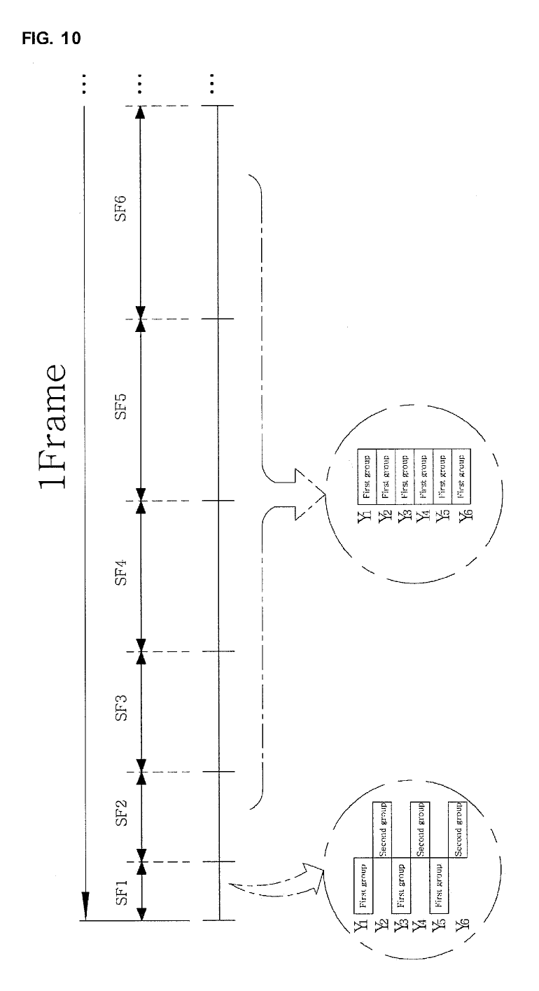

As above, in the case that the scan electrode groups are set, if the second scan type (Type2) of FIG. 10 is applied, scan signals are consecutively supplied to the scan electrodes belonging to the first scan electrode group, i.e., the first, second, and third scan electrodes Y1, Y2, and Y3, then scan signals are consecutively supplied to the scan electrodes belonging to the third scan electrode group, i.e., the seventh, eighth, and ninth scan electrodes Y7, Y8, and Y9, then scan signals are consecutively supplied to the scan electrodes belonging to the second scan electrode group, i.e, the fourth, fifth, and sixth scan electrodes Y4, Y5, and Y6, and then scan signals are consecutively supplied to the scan electrodes belonging to the fourth scan electrode group, i.e., the tenth, eleventh, and twelfth scan electrodes Y10, Y11, and Y12.

As above, it is possible to apply a scan type for consecutively supplying scan signals to at least one scan electrode belonging to at least one of the plurality of scan electrode groups.

FIG. 10 illustrates one example of a method for determining a scan type in consideration of a subfield.

Referring to FIG. 10, the order of supplying the scan signals to the plurality of scan electrodes in at least one subfield of a frame may be different from the order of supplying the scan signals to the plurality of scan electrodes in other subfields. In other words, it is possible to determine the scan type in consideration of a subfield. For example, the second scan type (Type2) of FIG. 6 is used in the first subfield SF1 and the first scan type (Type1) of FIG. 6 is used in the remaining subfields such that the displacement current is minimized.

The following is a detailed description of a case where the scan driver of the plasma display apparatus according to the embodiment consecutively supplies a first scan signal and a second scan signal to a first scan electrode and a second scan electrode of the plurality of scan electrodes, and a supply end time point of the first scan signal is later than a supply start time point of the second scan signal.

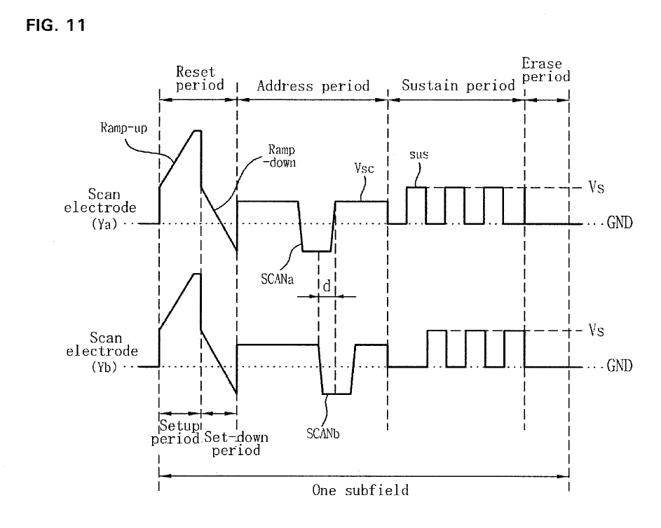

FIG. 11 illustrates one example of a waveform of a driving signal of the plasma display apparatus according to the embodiment.

During a setup period of a reset period, a rising signal (Ramp-up) is supplied to scan electrodes Ya and Yb. The rising signal (Ramp-up) generates a weak dark discharge (i.e., a setup discharge) within all the discharge cells of the whole screen. This results in wall charges of a positive polarity being accumulated on the data electrodes and the sustain electrodes, and wall charges of a negative polarity being accumulated on the scan electrodes Ya and Yb.

During a set-down period, a falling signal (Ramp-down) which falls from a positive voltage lower than a peak voltage of the rising signal (Ramp-up) to a given voltage lower than a ground level voltage GND is supplied to the scan electrodes Ya and Yb, thereby generating a weak erase discharge within the discharge cells. Furthermore, the remaining wall charges are uniform inside the cells to the extent that the address discharge can be stably performed.

During an address period, the scan electrodes Ya and Yb are scanned. In other words, during the address period, scan signals SCANa and SCANb falling from a scan reference voltage Vsc are supplied to the scan electrodes Ya and Yb, and data signals of a positive polarity corresponding to the scan signals SCANa and SCANb are supplied to the data electrodes.

When the scan driver 110 of FIG. 1 consecutively supplies the scan signals SCANa and SCANb to the scan electrodes Ya and Yb, a supply end time point of the scan signal SCANa supplied to the Ya scan electrode is later than a supply start time point of the scan signal SCANb supplied to the Yb scan electrode by a predetermined interval of time d. In other words, the scan signal SCANa supplied to the Ya scan electrode overlaps the scan signal SCANb supplied to the Yb scan electrode.

As the voltage difference between the scan signals SCANa and SCANb and the data signals is added to the wall voltage generated during the reset period, an address discharge occurs within the discharge cells to which the data signals are supplied. Wall charges are formed inside the discharge cells selected by performing the address discharge such that when a sustain voltage Vs is supplied a discharge occurs.

During a sustain period, sustain signals (sus) are alternately supplied to the scan electrodes Ya and Yb and the sustain electrodes. As the wall voltage within the discharge cells selected by performing the address discharge is added to the sustain signals (sus), every time the sustain signals (sus) are supplied, a sustain discharge occurs between the scan electrodes Ya and Yb and the sustain electrodes.

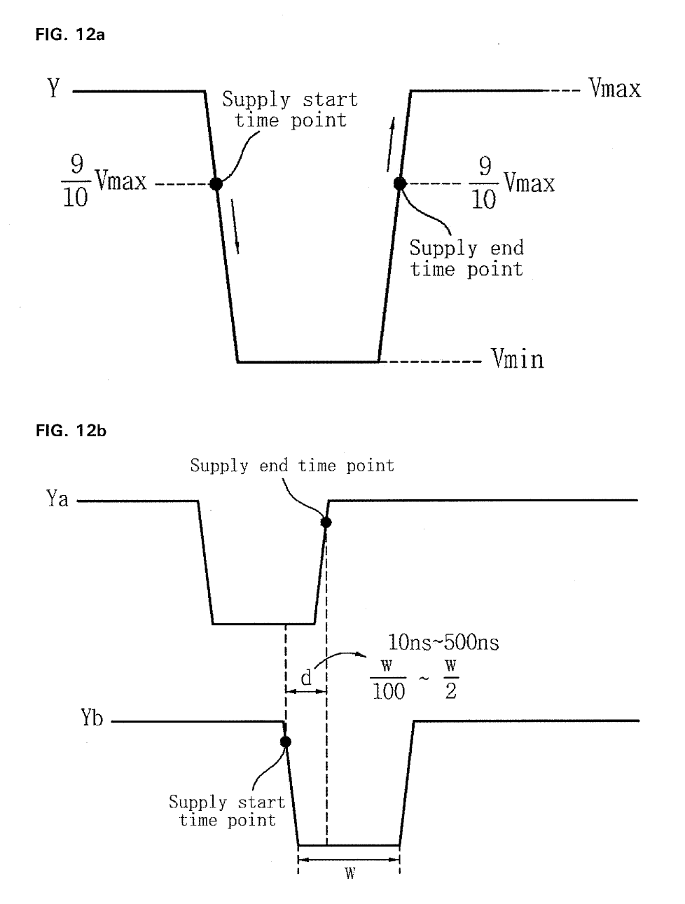

FIGS. 12a and 12b illustrate a supply start time point and a supply end time point of a scan signal for driving the plasma display apparatus according to the embodiment.

As illustrated in FIG. 12a, a supply start time point of a scan signal supplied to the scan electrode Y is a supply time point of a voltage ranging from the lowest voltage Vmin of the scan signal to a voltage ( 9/10)Vmax corresponding to 90% of the highest voltage Vmax of the scan signal when a voltage of the scan signal supplied to the scan electrode Y falls from the highest voltage Vmax of the scan signal. Further, a supply end time point of a scan signal supplied to the scan electrode Y is a supply time point of a voltage ranging from the voltage ( 9/10)Vmax corresponding to 90% of the highest voltage Vmax of the scan signal to the highest voltage Vmax of the scan signal when a voltage of the scan signal supplied to the scan electrode Y rises from the lowest voltage Vmin of the scan signal.

As illustrated in FIG. 12b, when the scan driver 110 of FIG. 1 consecutively supplies scan signals to the two scan electrodes Ya and Yb, a supply end time point of the scan signal supplied to the Ya scan electrode is later than a supply start time point of the scan signal supplied to the Yb scan electrode by a predetermined interval of time d.

Therefore, a portion of the scan signal supplied to the Ya scan electrode overlaps a portion of the scan signal supplied to the Yb scan electrode such that a duration of the address period shortens and sufficient driving time is secured.

More specifically, one frame, as illustrated in FIG. 3, comprises a plurality of subfields, and each of the plurality of subfields comprises a reset period, an address period, and a sustain period. When the scan signals supplied in a consecutive order overlap partially, a duration of the address period shortens and a duration of the sustain period lengthens. Accordingly, a total luminance of an image which the plasma display apparatus displays increases.

The predetermined interval of time d between the supply end time point of the scan signal supplied to the Ya scan electrode and the supply start time point of the scan signal supplied to the Yb scan electrode may range from 1/100 to ½ times the width of the scan signal. Further, the predetermined interval of time d between the supply end time point of the scan signal supplied to the Ya scan electrode and the supply start time point of the scan signal supplied to the Yb scan electrode may range from 10 ns to 500 ns. When the predetermined interval of time d is equal to or more than 1/100 times the width of the scan signal or is equal to or more than 10 ns, the duration of the sustain period is sufficiently secured. Further, when the predetermined interval of time d is equal to or less than ½ times the width of the scan signal or is equal to or less than 500 ns, an erroneous discharge, which is likely to occur between the adjacent scan electrodes, is prevented.

Although scan signals supplied to two scan electrodes in a consecutive order has been so far compared, the following is a detailed description of a relationship between scan signals supplied to three scan electrodes in a consecutive order.

FIG. 13 illustrates the supplying of scan signals to three or more scan electrodes of the plasma display apparatus according to the embodiment in a consecutive order. As illustrated in FIG. 13, when the scan driver 110 of FIG. 1 consecutively supplies scan signals to scan electrodes Y1 to Y4, a supply end time point of the scan signal supplied to the Y1 scan electrode is later than a supply start time point of the scan signal supplied to the Y2 scan electrode by a predetermined interval of time d. Further, a supply end time point of the scan signal supplied to the Y2 scan electrode is later than a supply start time point of the scan signal supplied to the Y3 scan electrode by a predetermined interval of time d. A supply end time point of the scan signal supplied to the Y3 scan electrode is later than a supply start time point of the scan signal supplied to the Y4 scan electrode by a predetermined interval of time d. In other words, the scan signals supplied to the adjacent two scan electrodes overlap partially.

Although the scan driver 110 of FIG. 1 supplies the scan signals illustrated in FIG. 13 using the first scan type (Type 1) of FIG. 6, the scan signals illustrated in FIG. 13 may be supplied using the second scan type (Type2) to the fourth scan type (Type4). For example, the supplying of the scan signals illustrated in FIG. 13 using the second scan type (Type2) is illustrated in FIG. 14.

FIG. 14 illustrates an example of scan signals supplied by a scan driver of the plasma display apparatus according to the embodiment using a second scan type. As illustrated in FIG. 14, the scan driver 110 of FIG. 1 supplies scan signals to the Y1 scan electrode, the Y3 scan electrode, the Y2 scan electrode, and the Y4 scan electrode in the order named.

A supply end time point of the scan signal supplied to the Y1 scan electrode is later than a supply start time point of the scan signal supplied to the Y3 scan electrode by a predetermined interval of time d. A supply end time point of the scan signal supplied to the Y3 scan electrode is later than a supply start time point of the scan signal supplied to the Y2 scan electrode by a predetermined interval of time d. A supply end time point of the scan signal supplied to the Y2 scan electrode is later than a supply start time point of the scan signal supplied to the Y4 scan electrode by a predetermined interval of time d.

In other words, in the plasma display panel 200 of FIG. 1, the Y1 scan electrode, the Y2 scan electrode, the Y3 scan electrode, and the Y4 scan electrode are disposed in the order named. However, the scan driver 110 of FIG. 1 supplies the scan signals to the Y1 scan electrode, the Y3 scan electrode, the Y2 scan electrode, and the Y4 scan electrode in the order named. Further, the two scan signals supplied in a consecutive order partially overlaps.

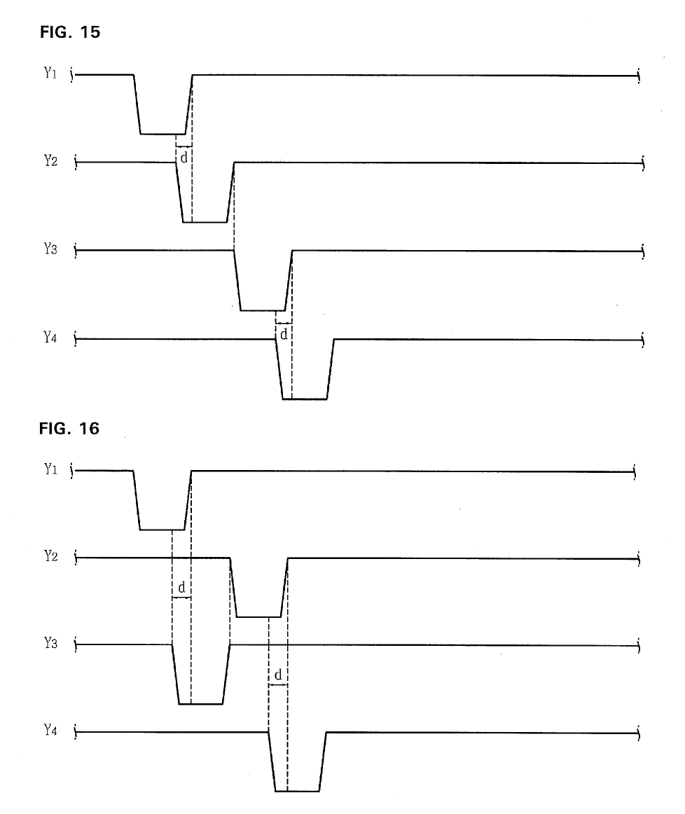

FIGS. 13 and 14 illustrate a case where all the scan signals partially overlap. FIG. 15 illustrates a case where a portion of all the scan signals partially overlaps.

FIG. 15 illustrates another example of scan signals supplied by a scan driver of the plasma display apparatus according to the embodiment using a first scan type. As illustrated in FIG. 15, the scan driver 110 of FIG. 1 consecutively supplies scan signals to the scan electrodes Y1 to Y4. A supply end time point of the scan signal supplied to the Y1 scan electrode is later than a supply start time point of the scan signal supplied to the Y2 scan electrode by a predetermined interval of time d. On the other hand, a supply end time point of the scan signal supplied to the Y2 scan electrode is earlier than or is equal to a supply start time point of the scan signal supplied to the Y3 scan electrode. Further, a supply end time point of the scan signal supplied to the Y3 scan electrode is later than a supply start time point of the scan signal supplied to the Y4 scan electrode by a predetermined interval of time d.

FIG. 16 illustrates another example of scan signals supplied by a scan driver of the plasma display apparatus according to the embodiment using a second scan type. As illustrated in FIG. 16, the Y1 scan electrode, the Y2 scan electrode, the Y3 scan electrode, and the Y4 scan electrode are disposed in the order named. The scan driver 110 of FIG. 1 supplies scan signals to the Y1 scan electrode, the Y3 scan electrode, the Y2 scan electrode, and the Y4 scan electrode in the order named using the second scan type (Type2).

A supply end time point of the scan signal supplied to the Y1 scan electrode is later than a supply start time point of the scan signal supplied to the Y3 scan electrode by a predetermined interval of time d. A supply end time point of the scan signal supplied to the Y3 scan electrode is earlier than or is equal to a supply start time point of the scan signal supplied to the Y2 scan electrode. Further, a supply end time point of the scan signal supplied to the Y2 scan electrode is later than a supply start time point of the scan signal supplied to the Y4 scan electrode by a predetermined interval of time d.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. A plasma display apparatus, comprising:
a plurality of scan electrodes;
a plurality of data electrodes supplied with a data signal;
a scan driver for supplying scan signals to the plurality of scan electrodes using a first scan type in a first subfield of a frame, and for supplying the scan signals to the plurality of scan electrodes using a second scan type, which directs the scan driver to supply the scan signals in an order different from the first scan type, in a second subfield of the frame; and
a data driver for supplying data signals corresponding to the scan signals supplied in the first subfield and the second subfield to the plurality of data electrodes,
wherein the scan driver consecutively supplies a first scan signal and a second scan signal to a first scan electrode and a second scan electrode of the plurality of scan electrodes, and
a supply end time point of the first scan signal is later than a supply start time point of the second scan signal.

2. The plasma display apparatus of claim 1, wherein the number of times of switching of the data driver with respect to the first scan type in the first subfield is less than the number of times of switching of the data driver with respect to the second type in the first subfield.

3. The plasma display apparatus of claim 2, wherein the number of switching operations of the data driver equals the number of changes in a voltage level of the data signal.

4. The plasma display apparatus of claim 1, wherein at least one of the first scan type and the second scan type comprises a scan type for consecutively supplying the scan signals to the odd-numbered scan electrodes and then to the even-numbered scan electrodes, or for consecutively supplying the scan signals to the even-numbered scan electrodes and then to the odd-numbered scan electrodes.

5. The plasma display apparatus of claim 1, wherein the plurality of scan electrodes comprise a first scan electrode, a second scan electrode, and a third scan electrode, adjacent to one another, to which the scan signals are supplied in a consecutive order, and
a distance between the first scan electrode and the second scan electrode is substantially equal to a distance between the second scan electrode and the third scan electrode.

6. The plasma display apparatus of claim 1, wherein the scan driver supplies the scan signals to the scan electrodes using one of the first scan type and the second scan type, in which the number of times of switching of the data driver is less than the other, in response to image data input for each subfield of the frame.

7. The plasma display apparatus of claim 1, wherein at least one of the first scan type and the second scan type comprises a scan type for consecutively supplying the scan signals to the scan electrodes of one scan electrode group.

8. The plasma display apparatus of claim 1, wherein the scan driver supplies the scan signals to the plurality of scan electrodes using at least one of the first scan type and the second scan type, in which the number of switching operations of the data driver in response to input image data is equal to or less than a threshold value.

9. The plasma display apparatus of claim 1, wherein when the number of switching operations of the data driver with respect to the first scan type in response to input image data is equal to or more than a threshold value, the scan driver supplies the scan signals to the scan electrodes using the second scan type.

10. The plasma display apparatus of claim 1, wherein the first scan type comprises a scan type for consecutively supplying the scan signals to the plurality of scan electrodes, and
the scan driver supplies the scan signals to the scan electrodes using the first scan type when the number of switching operations of the data driver with respect to the first scan type in response to input image data is equal to or less than a threshold value, and the scan driver supplies the scan signals to the scan electrodes using the second scan type when the number of switching operations of the data driver with respect to the first scan type in response to input image data is equal to or more than the threshold value.

11. The plasma display apparatus of claim 1, wherein the supply start time point of the second scan signal occurs when a voltage of the second scan electrode is equal to or less than 90% of the highest voltage of the second scan signal.

12. The plasma display apparatus of claim 1, wherein the supply end time point of the first scan signal occurs when a voltage of the first scan electrode is equal to or more than 90% of the highest voltage of the first scan signal.

13. The plasma display apparatus of claim 1, wherein an interval of time between the supply end time point of the first scan signal and the supply start time point of the second scan signal ranges from 10 ns to 500 ns.

14. The plasma display apparatus of claim 1, wherein an interval of time between the supply end time point of the first scan signal and the supply start time point of the second scan signal ranges from 1/100 to ½ times the width of the first scan signal or the second scan signal.

15. A method of driving a plasma display apparatus comprising a plurality of scan electrodes and a plurality of data electrodes, comprising:
supplying scan signals to the plurality of scan electrodes using a first scan type in a first subfield of a frame;
supplying the scan signals to the plurality of scan electrodes using a second scan type, which is different from the first scan type in an order of supplying the scan signals, in a second subfield of the frame; and
supplying data signals corresponding to the scan signals supplied in the first subfield and the second subfield to the plurality of data electrodes,
wherein a first scan signal and a second scan signal are consecutively supplies to a first scan electrode and a second scan electrode of the plurality of scan electrodes, and
a supply end time point of the first scan signal is later than a supply start time point of the second scan signal.

16. The method of claim 15, wherein the supply start time point of the second scan signal occurs when a voltage of the second scan electrode is equal to or less than 90% of the highest voltage of the second scan signal.

17. The method of claim 15, wherein the supply end time point of the first scan signal occurs when a voltage of the first scan electrode is equal to or more than 90% of the highest voltage of the first scan signal.

18. The method of claim 15, wherein an interval of time between the supply end time point of the first scan signal and the supply start time point of the second scan signal ranges from 10 ns to 500 ns.

19. The method of claim 15, wherein an interval of time between the supply end time point of the first scan signal and the supply start time point of the second scan signal ranges from 1/100 to ½ times the width of the first scan signal or the second scan signal.
